(19) United States
(12) Patent Application Publication
(10) Pub. No.: US 2014/0300760 A1
(43) Pub. Date: Oct. 9, 2014

(54) ELECTRONIC APPARATUS AND METHOD OF CONTROLLING THE SAME

(71) Applicant: SAMSUNG ELECTRONICS CO., LTD., Suwon-si (KR)

(72) Inventor: Se Hyun Lee, Seongnam-si (KR)

(73) Assignee: SAMSUNG ELECTRONICS CO., LTD., Suwon-si (KR)

(21) Appl. No.: 14/246,520

(22) Filed: Apr. 7, 2014

(30) Foreign Application Priority Data
Apr. 8, 2013 (KR) 10-2013-0038244

(51) Int. Cl. H04N 5/232

(52) U.S. Cl. CPC H04N 5/23296
USPC 348/207.1

(57) ABSTRACT

Disclosed herein is an electronic apparatus. The electronic apparatus includes a main body, an image capturing module, a detection unit, a controller, and an output unit. The image capturing module is mounted on the main body and acquires an image of an object. The detection unit is mounted on the main body and detects an angle of the main body with respect to a horizontal line, where the horizontal line is perpendicular to an optical axis of a lens of the image capturing module and is parallel to the horizon. The controller determines a photographing angle of the object based on the detected angle of the main body. The output unit outputs information regarding the photographing angle to an external device.

### CROSS-REFERENCE TO RELATED PATENT APPLICATION(S)

This application claims the priority benefit of Korean Patent Application No. 10-2013-0038244, filed on Apr. 8, 2013 in the Korean Intellectual Property Office, the disclosure of which is incorporated herein in its entirety by reference.

### BACKGROUND

1. Field

Embodiments of the invention relate to an electronic apparatus that adjusts a photographing angle while an image of an object is captured and a method of controlling the same.

2. Related Art

An imaging apparatus is a device that takes still photographs or video by recording images of human beings, objects, and landscapes. Recently, development of digital imaging apparatuses, which obtain data from light incident upon an image pickup device and store the data in a storage medium as a file or display an image on a display unit, has been vigorously carried out.

A digital imaging apparatus includes a digital camera that captures images as a primary function. The digital imaging apparatus may be incorporated into many terminal devices such as mobile phones, personal digital assistants (PDAs), notebook computers, and personal computers (PCs) in an integrated or separated manner as an imaging module including elements required to capture images of the object.

While an image of an object is captured using such an imaging apparatus, a photographing angle needs to be adjusted. In this regard, a user may adjust the photographing angle by moving a main body provided with an imaging module and confirm adjustment via a display unit. However, since it is a time-consuming process to receive an image of the object by an image pickup device of the imaging module and then display the image on the display unit, it is difficult for the user to capture the image with a desired photographing angle at a suitable time.

In addition, when the display unit is not within a user's view, for example, in high-angle shot or low-angle shot, the user cannot confirm the image displayed on the display unit, so that it is difficult to adjust the photographing angle.

In particular, a device that is more compact and lighter than a camera is often held in one hand to capture an image, and thus a user has a difficulty adjusting the photographing angle as desired.

That is, when a main body of the camera or the device is tilted while an image of the object is captured, an imaging module capturing an image of the object is tilted, too. When an image of the object is captured by the imaging module in a state of being tilted, the image of the object is tilted with respect to the horizontal line.

When image data acquired thereby is confirmed on a display unit of a terminal or a computer monitor, the image of the object appears tilted while a frame of the display unit is not tilted.

In this case, the user may deliberately tilt the photographing angle to one side. However, when the user tries to acquire an image in which the horizontal line and the vertical line of the frame are identical to those of the image, the tilted image needs to be rotated using a rotation function of an image viewer in order to obtain an image that is not tilted. This complicates the process of capturing and outputting an image.

In addition, when a tilted image is rotated to level the image and unnecessary portions are removed, only a portion of the original image is acquired as a new image, so that a desired viewing angle is not obtainable. Particularly, images captured for special applications, such as images used in construction fields or used as press photos, may have an unsettled composition.

### SUMMARY

Therefore, various embodiments provide an electronic apparatus that detects a tilt of a main body provided with an image capturing module and outputs information regarding a photographing angle to a user based on the detection result, and a method of controlling the same.

Various embodiments also provide an electronic apparatus that outputs information regarding a photographing angle via an external device while an image of an object is captured, and a method of controlling the same.

Various embodiments further provide an electronic apparatus that receives a desired photographing angle from a user and outputs photographing angle information regarding a tilt of a main body to the user such that the angle of the main body with respect to the horizontal line is identical to the received photographing angle while an image of the object is captured, and a method of controlling the same.

Additional features will be set forth in part in the description which follows and, in part, will become obvious from the description, or may be learned by practice of the embodiments.

In accordance with an embodiment, an electronic apparatus includes a main body, an image capturing module, a detection unit, a controller, and an output unit. The image capturing module is mounted on the main body and acquires an image of an object. The detection unit is mounted on the main body and detects an angle of the main body with respect to a horizontal line, where the horizontal line is perpendicular to an optical axis of a lens of the image capturing module and is parallel to the horizon. The controller determines a photographing angle of the object based on the angle of the main body. The output unit outputs information regarding the photographing angle to an external device.

The photographing angle may include a horizontal angle at which the main body is parallel to the horizontal line, and a canted angle at which the main body is tilted to the left or right with respect to the horizontal line.

The output unit may include an interface unit that communicates with the external device via a wired connection, and the controller may control output of information regarding the horizontal angle and the canted angle to the external device via the interface unit.

The output unit may include a communication unit that communicates with to the external device via a wireless connection, and the controller may control output of information regarding the horizontal angle and the canted angle to the external device via the communication unit.

The electronic apparatus may further include a storage unit that stores output information respectively corresponding to the horizontal angle and the canted angle. The controller may control output of output information corresponding to the horizontal angle when the photographing angle is the horizontal angle, and the controller controls output of output information corresponding to the canted angle when the photographing angle is the canted angle.

The output information corresponding to the horizontal angle may be different from the output information corresponding to the canted angle.

The controller may determine whether the canted angle is a left tilt, where the main body is tilted to the left with respect to the horizontal line, or a right tilt, where the main body is tilted to the right with respect to the horizontal line. The controller may control output of output information corresponding to the right tilt when the canted angle is the right tilt and control output of output information corresponding to the left tilt when the canted angle is the left tilt.

The output information corresponding to the left tilt may be different from the output information corresponding to the right tilt.

The output unit may include a sound output unit that outputs output information corresponding to the horizontal angle, the right tilt, and the left tilt, using different sounds.

The output unit may include a vibration unit that indicates output information corresponding to the horizontal angle and the canted angle using vibrations.

The electronic apparatus may further include a display unit mounted on the main body and displays an image of the object acquired using the image capturing module.

The display unit may display information regarding the horizontal angle and the canted angle.

The electronic apparatus may further include an input unit through which an information output mode to output information regarding the photographing angle is input. The information output mode may include at least one mode selected from the group consisting of a sound mode, an announcement mode, a display mode, a vibration mode, a first external mode, and a second external mode.

The electronic apparatus may further include an input unit through which a target angle of the main body tilted with respect to the horizontal line is input. The controller may determine whether the photographing angle is the target angle and controls the output unit to output information regarding an image capture time when the photographing angle is identical to the target angle.

In accordance with another embodiment, a method of controlling an electronic apparatus including an image capturing module includes: detecting an angle of the image capturing module with respect to a horizontal line when a command to initiate image capture is received, where the horizontal line is perpendicular to an optical axis of a lens of the image capturing module and is parallel to the horizon, determining a photographing angle of an object based on the detected angle, determining whether the determined photographing angle is a horizontal angle or a canted angle, and outputting information regarding the determined photographing angle to an external device.

The determining of the photographing angle may include determining whether the canted angle is a left tilt, where the image capturing module is tilted to the left with respect to the horizontal line, or a right tilt, where the image capturing module is tilted to the right with respect to the horizontal line. The outputting of information may include outputting information regarding the right tilt when the camera angle is the right tilt and outputting information regarding the left tilt when the canted angle is left tilt.

The detecting of the angle of the image capturing module may include confirming a frame mode and detecting the angle of the image capturing module with respect to the horizontal line.

The outputting of information may include outputting information using at least one mode selected from the group consisting of a sound mode, an announcement mode, and a vibration mode.

The outputting of information may include transmitting a left tilt signal to the external device when the photographing angle is a left tilt, transmitting a right tilt signal to the external device when the photographing angle is a right tilt, and transmitting a horizontal angle signal to the external device when the photographing angle is the horizontal angle.

The left tilt signal may be a signal output through a first audio unit of the external device, the right tilt signal may be a signal output through a second audio unit of the external device, and the horizontal angle signal may be a signal output through at least one of the first audio unit and second audio unit of the external device.

The left tilt signal, the right tilt signal, and the horizontal angle signal may be different sound signals.

The transmitting the signals to the external device may include transmitting the signals to a sound output device, which communicates with the electronic apparatus via a wired or wireless connection.

According to various embodiments, the photographing angle may be quickly adjusted even when information regarding the photographing angle is not obtainable through the display unit, by providing the photographing angle information to the user using audio-visual signals and touch signals. Accordingly, an image of the object captured at a desired photographing angle and the horizontal angle may be efficiently acquired.

As described above, since an image of the object having a consistent pattern is captured at the horizontal angle, the image may have improved rhythmical sense and symmetry.

Furthermore, by outputting information regarding the photographing angle, which is information regarding the left or right tilt, via the external device, the user may immediately adjust the photographing angle even in an environment where audio signals regarding the photographing angle information are not obtainable due to loud noises.

### BRIEF DESCRIPTION OF THE DRAWINGS

These and/or other aspects will become apparent and more readily appreciated from the following description of the embodiments, taken in conjunction with the accompanying drawings of which:

FIG. 1(a) exemplarily illustrates an electronic apparatus, according to an embodiment;

FIG. 1(b) exemplarily illustrates an external device communicating with an electronic apparatus, according to an embodiment;

FIG. 2 is a control block diagram illustrating an electronic apparatus and an external device, according to an embodiment;

FIG. 3 is a flowchart illustrating a method for controlling an electronic apparatus, according to an embodiment;

FIG. 4 is a flowchart illustrating a method for controlling a sound output device, as an external device, communicating with an electronic apparatus, according to an embodiment; and

FIGS. 5 to 8 exemplarily illustrate various output modes of an electronic apparatus, according to various embodiments.

### DETAILED DESCRIPTION

Reference will now be made in detail to the embodiments, examples of which are illustrated in the accompanying drawings, wherein like reference numerals refer to like elements throughout.

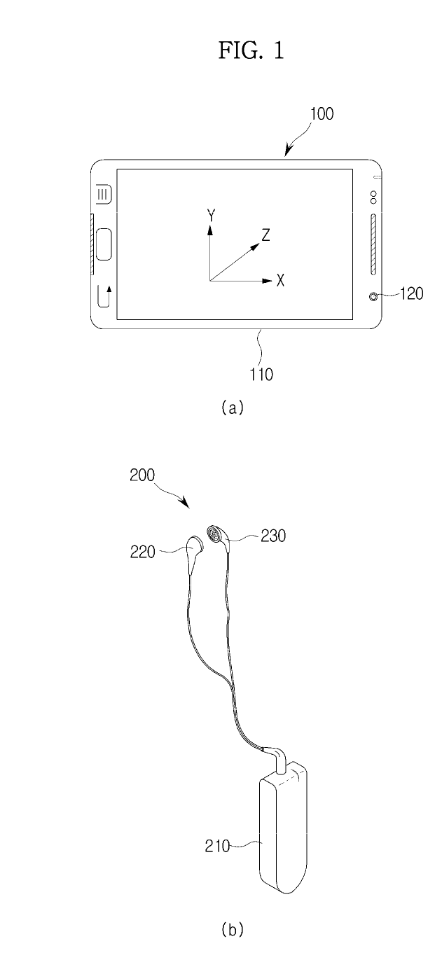

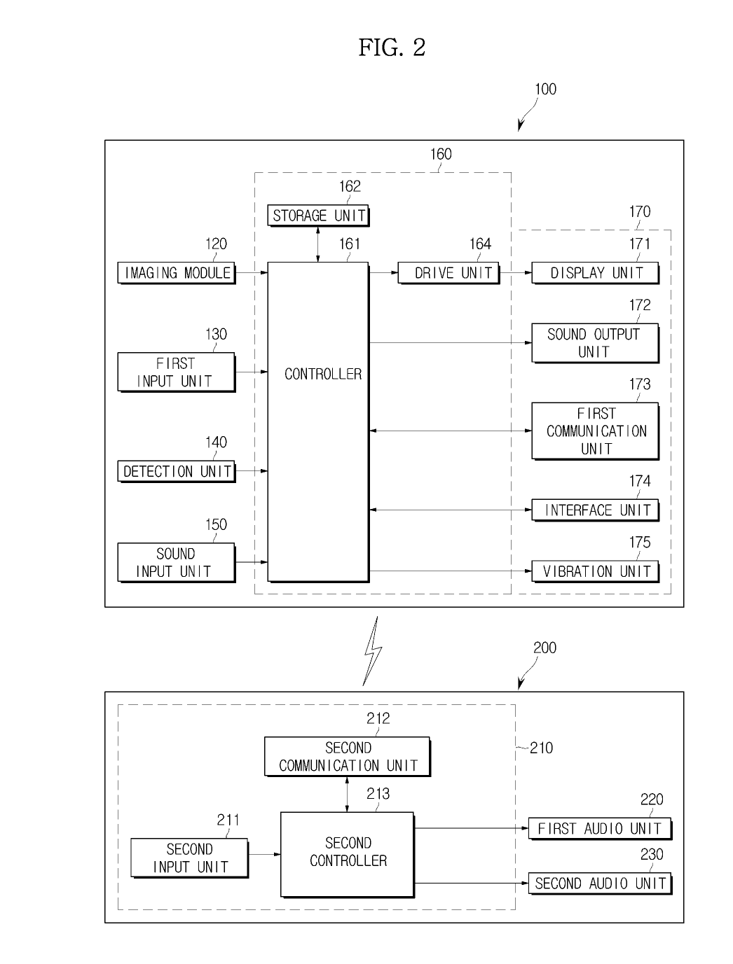

FIG. 1(a) exemplarily illustrates an electronic apparatus, e.g., an image capturing apparatus, according to an embodiment. FIG. 1(b) exemplarily illustrates an external device communicating with an electronic apparatus, according to an embodiment. FIG. 2 is a control block diagram illustrating an electronic apparatus and an external device, according to an embodiment.

The electronic apparatus includes a digital camera acquiring a still image and a moving image, as a primary function, and a terminal device additionally having an image capturing module capable of acquiring a still image and a moving image. Here, the terminal device may include a mobile phone, a personal digital assistant (PDA), a notebook computer, a personal computer (PC), a tablet PC, and other devices having image capturing capabilities.

The terminal device having an image capturing module may be used to place voice calls and video calls, display content, operate applications, perform wired and wireless communications, and output sound signals to an external sound output device 200 via wired and/or wireless communication in addition to the function of capturing images. Here, the external sound output device 200 includes a body 210 for electrical and communicational connection with the terminal device and a first audio unit 220 and a second audio unit 230, which are connected to the body 210 and output electrical signals received from the body 210 toward left and right ears as sounds.

The sound output device 200 includes at least one device selected from the group consisting of wireless earphones, wireless headphones, wired earphones, and wired headphones.

According to the illustrated embodiment, a smartphone will be exemplarily described as the electronic apparatus 100, and wireless earphones will be exemplarily described as the sound output device 200.

As illustrated in FIGS. 1(a) and 2, the electronic apparatus 100 includes a main body 110, an image capturing module 120, a first input unit 130, a detection unit 140, a display unit 171, a sound output unit 172, a driving module 160, and an output unit 170.

The main body 110 forms an outer appearance of the electronic apparatus 100. In the main body 110, the image capturing module 120, the first input unit 130, the detection unit 140, the display unit 171, the sound output unit 172, the driving module 160, and the output unit 170 are disposed.

The image capturing module 120 is mounted on the main body 110 in a fixed or separated manner and acquires an image of an external object.

The image capturing module 120 is mounted on the main body 110 such that an axis of the main body 110, which is perpendicular to an optical axis of a lens of the image capturing module 120, corresponds to an X-axis of the main body 110.

The image capturing module 120 converts the image of the object into electrical signals, converts the electrical signals into digital signals, and then transmits the digital signals to a storage unit. The image capturing module 120 includes a lens, an iris, an image sensor such as a charge coupled device (CCD) or a complementary metal oxide semiconductor (CMOS), an RGB color filter, and an analog-to-digital (A/D) converter.

Principles of capturing an image by an image capturing module will be briefly described. When a shutter button of the image capturing module is pressed, light is allowed to pass through the lens and the iris. In this case, light passing through the lens and the iris arrives at a CCD, as an image sensor, and the intensity of the light from the lens is recorded in the CCD.

In this regard, the CCD is a light sensitive semiconductor device that converts light into electrical signals. Light from the captured image is split into different colors by the RGB filter adjacent to the CCD, and the split colors are converted into electrical signals by hundreds of thousands of photosensitive devices constituting the CCD.

In this regard, the electrical signal is converted into 0 or 1, as a digital signal, by the A/D converter so as to be converted into an image file.

The first input unit 130 transmits a command input by a user to the driving module 160.

The first input unit 130 receives an input command to initiate or end an image capture operation, an input command to turn on or turn off an information output mode, which outputs information regarding the photographing angle, and a selected output mode to output information regarding the photographing angle.

In this regard, the photographing angle refers to an angle indicating the position of the electronic apparatus 100 in relation to the object and includes a horizontal angle and a canted angle. The photographing angle is determined with respect to a horizontal line that is perpendicular to the optical axis and parallel to the horizon.

The horizontal angle for an eye level shot refers to a photographing angle in which the optical axis of the lens is perpendicular to the horizontal line and the object is parallel to the horizontal line, and the horizontal angle is used to make a settled image.

The canted angle for a Dutch angle shot refers to a photographing angle that is characterized by being tilted off at an angle and is not parallel to the horizontal line by tilting the image capturing module by a predetermined angle between 0° to 90°.

Here, the output mode includes at least one mode selected from the group consisting of a sound mode, an announcement mode, a light emitting mode, a display mode, a vibration mode, a first external mode, and a second external mode.

The sound mode is a mode in which information regarding the horizontal angle and the canted angle is output as a sound, such as a beep. The announcement mode is a mode in which information regarding the horizontal angle and the canted angle is output as a voice. The light emitting mode is a mode in which information regarding the horizontal angle and the canted angle is output by turning on lighting devices having different colors. The display mode is a mode in which information regarding the horizontal angle and the canted angle is output on a display unit. The vibration mode is a mode in which information regarding the horizontal angle and canted angle is output as vibrations.

In the sound mode, the horizontal angle and the canted angle may be distinguished from each other by outputting different sounds, or the output sound may vary according to tilt direction based on the horizontal angle. In this case, the tilt direction includes a left tilt, where the electronic apparatus 100 or the image capturing module 120 is tilted to the left, and a right tilt, where the electronic apparatus 100 or the image capturing module 120 is tilted to the right.

Furthermore, in the sound mode, the volume of the sound may also be controlled based on the degree of deviation of the image capturing module 120 from a target angle.

In the light emitting mode, the horizontal angle and the canted angle may be distinguished from each other by turning on lighting units having different colors. Alternatively, the horizontal angle and the canted angle may also be distinguished from each other by turning off a lighting unit for the horizontal angle and turning on a lighting unit for the canted angle. In this case, different lighting units may be turned on according to the tilt direction based on the horizontal angle.

In addition, the first external mode is a mode in which information regarding the horizontal angle and canted angle is output to a first sound output device, which is an external device connected via a communication unit in a wireless manner, using an audio signal. The second external mode is a mode in which information regarding the horizontal angle and canted angle is output to a second sound output device, which is an external device connected to an interface unit, using an audio signal.

Here, the first sound output device 200 is a wireless sound output device capable of performing wireless communication, such as Bluetooth, and the second sound output device (not shown) is a wired sound output device capable of performing wired communication.

A frame mode indicating the orientation of the frame, such as horizontal or vertical orientation, may be input through the first input unit 130 when an image of the object is acquired.

Here, the frame mode includes a landscape mode, which refers to a mode in which the long side of the frame is horizontal and the short side is vertical, and a portrait mode, which refers to a mode in which the long side of the frame is vertical and the short side is horizontal.

In addition, when a canted angle shot is taken, a target angle may be input to the first input unit 130 by the user. When a horizontal angle shot is taken, the target angle is set to 0°.

For example, when a left tilted shot is taken in landscape mode, e.g., tilted to the left by 10°, the landscape mode is selected and the left canted angle of 10° is input through the first input unit 130.

In this case, when the main body 110 is tilted by 10° with respect to the X-axis, the electronic apparatus 100 outputs a sound indicating that the canted angle is the same as the target angle.

Furthermore, when the canted angle is greater than 10°, information on the left canted angle, indicating that the main body 110 is tilted to the left side of the target angle of 10°, is output. When the canted angle is less than 10°, information on the right canted angle, indicating that the main body 110 is tilted to the right side of the target angle of 10°, is output.

The first input unit 130 may be a touch panel and may be integrated with the display unit 171.

The detection unit 140 detects position or tilt of the main body 110 and includes at least one sensor (e.g., a gyro sensor) to detect rotational inertia and an acceleration sensor to detect acceleration with respect to the three axes.

In other embodiments, any other sensors capable of detecting position, tilt, or angle may also be used as the detection unit 140.

The detection unit 140 detects a horizontal tilt in the landscape mode with respect to the X-axis and detects a horizontal tilt in the portrait mode with respect to the Y-axis.

The detection unit 140 may detect a horizontal edge of an image acquired by the image capturing module 120 and then may detect an angle with respect to the horizontal line based on the detected horizontal edge.

A sound input unit 150 receives sound information related to images while acquiring a moving image. The sound input unit 150 may include a microphone.

The driving module 160 controls operations of the image capturing module 120 and the output unit 170 based on the command input to the first input unit 130 and information detected by the detection unit 140.

The driving module 160 includes a controller 161, a storage unit 162, and a drive unit 164.

The controller 161 controls operation of the image capturing module 120 when the image capture operation is selected via the first input unit 130.

The controller 161 sets photographing conditions based on the information input to the first input unit 130 before or while an image is captured.

Here, the photographing conditions include on/off control of the information output mode corresponding to output of information regarding the photographing angle, an output mode to select a method of outputting information regarding the photographing angle in the information output mode, a frame mode indicating the orientation of the frame, a target angle to take a Dutch angle shot, and the like.

When the information output mode is turned on and the target angle is not set, the controller 161 determines that the user is trying to take an eye level shot and estimates whether the angle detected by the detection unit 140 is the horizontal angle or the canted angle, and then controls output of the resultant information.

Here, information regarding the canted angle is information regarding how far the main body 110 is tilted, i.e., to the left or the right, with respect to the horizontal line.

That is, the controller 161 determines whether the determined angle is the horizontal angle. When the determined angle is the horizontal angle, the controller 161 controls output of information corresponding to the horizontal angle. When the determined angle is not the horizontal angle but a canted angle, the controller 161 controls output of information corresponding to the canted angle.

The controller 161 controls output of information corresponding to the right tilt when the determined angle is a right tilted angle and controls output of information corresponding to the left tilt when the determined angle is a left tilted angle.

When the information output mode is turned on and the target angle is set, the controller 161 determines the angle detected by the detection unit 140 and compares the determined angle with the target angle. When the determined angle is the same as the target angle based on the comparison, the controller 161 controls output of information indicating a suitable timing. When the determined angle is not the same as the target angle, the controller 161 controls output of information indicating that further adjustment of the angle is necessary.

In this regard, the controller 161 controls output of information indicating whether the main body 110 should be tilted to the left or the right side from the currently tilted position with respect to the target angle.

The controller 161 recognizes the frame mode selected by the user and determines an axis used to detect the angle based on the recognized frame mode.

That is, when the fame mode is the landscape mode, the controller 161 detects the angle of the tilt with respect to the X-axis. When the fame mode is the portrait mode, the controller 161 detects the angle of the tilt with respect to the Y-axis.

The controller 161 confirms the output mode selected by the user and controls operation of the output unit 170 based on the confirmed output mode.

For example, the controller 161 controls operation of the sound output unit 172 when the sound mode is selected by the user, controls output of a signal via the communication unit 173 when the first external mode is selected by the user, and controls output of a signal via the interface unit 174 when the second external mode is selected by the user.

The storage unit 162 stores a captured image.

The storage unit 162 also stores information regarding the photographing conditions preset by the user.

For example, the storage unit 162 stores a sound corresponding to the left tilt, a sound corresponding to the right tilt, and a sound corresponding to the horizontal angle, respectively, and stores a volume of a sound corresponding to an angle greater than the target angle.

In addition, when the photographing conditions are not preset by the user, the storage unit 162 sets the horizontal angle as the target angle and stores the angle. Here, in the horizontal angle, the target angle is 0°.

The electronic apparatus 100 may respectively include a storage unit to store an image and a storage unit to store data for controlling the image.

The drive unit 163 drives the display unit 171 such that an image is displayed on the display unit 171 according to a command from the controller 161.

The output unit 170 outputs information in accordance with the command from the controller 161 and includes a display unit 171, a sound output unit 172, a first communication unit 173, an interface unit 174, and a vibration unit 175.

The display unit 171 is disposed in the main body 110 and displays an image of the object acquired by the image capturing module 120.

That is, the display unit 171 may display an image of the object captured by the image capturing module 120 during the image capture operation and may display an image stored in the storage unit according to the command of the user.

The display unit 171 may be a touchscreen. The touchscreen may display various information while receiving a command from a user.

The sound output unit 172 outputs information regarding the photographing angle using a sound. In addition, the sound output unit 172 outputs a sound of a moving image while reproducing the moving image stored in the storage unit.

The sound output unit 172 may also output sound of content while reproducing the content. The sound output unit 172 may include a speaker.

The first communication unit 173 performs wireless communications with an external sound output device. That is, the first communication unit 173 transmits a signal regarding the photographing angle in a wireless manner according to the command from the controller 161.

In addition, when the terminal device (e.g., electronic apparatus 100) is currently in a call mode, the first communication unit 173 transmits audio signals to the user and receives audio signals from the user.

The interface unit 174 is a port with which the second sound output device, which is an external device, is connected in a wired manner. Communications may be performed between the driving module 160 and the external device via the interface unit 174.

That is, the interface unit 174 transmits a signal regarding the photographing angle output from the driving module 160 to the external sound output device connected thereto in a wired manner.

The vibration unit 175 is disposed in the main body 110 and generates vibrations based on a command from the controller 161.

For example, under the condition that an eye level shot of the object is taken, vibrations are not generated when the photographing angle of the image capturing module 120 is the horizontal angle, and vibrations are generated when the photographing angle is a canted angle. In addition, the intensity of vibrations or vibration generation time of the vibration unit 175 may vary according to the degree of deviation from the target angle.

Furthermore, the vibration units 175 may be disposed at edges of the main body 110, and only the vibration unit 175 positioned at one edge tilted more than the other edge may be vibrated.

The sound output device 200 includes a body 210 and a first audio unit 220 and a second audio unit 230, which are connected to the body 210 in a wired manner.

The body 210 includes elements to control communications with the terminal device (e.g., electronic apparatus 100) including the image capturing module 120 and to control output of the sound. The body 210 includes a second input unit 211, a second communication unit 212, and a second controller 213.

Information such as a command to turn on or off a power supply, a volume of the sound, and the like, is input to the second input unit 211.

The second input unit 211 may also receive a command for pairing with the terminal device.

The second communication unit 212 performs communications with the terminal device, receives signals from the terminal device, and transmits the signals to the second controller 213.

When the power is turned on and the sound signals are received through the second communication unit 212, the second controller 213 determines whether the signals are received from the left side or the right side and outputs electrical signals to an audio unit in the determined direction.

That is, the second controller 213 outputs the electrical signals to the first audio unit 220 when the sound signals are received from the left side and outputs the electrical signals to the second audio unit 230 when the sound signals are received from the right side. When the received sound signals are sound signals received from both the left and right sides, the sound controller 213 outputs the electrical signals to the first audio unit 220 and the second audio unit 230.

The first audio unit 220, which is a left earphone applied to the left ear, converts electrical signals received from the second controller 213 into audio signals and outputs the audio signals. The second audio unit 230, which is a right earphone applied to the right ear, converts electrical signals received from the second controller 213 into audio signals and outputs the audio signals.

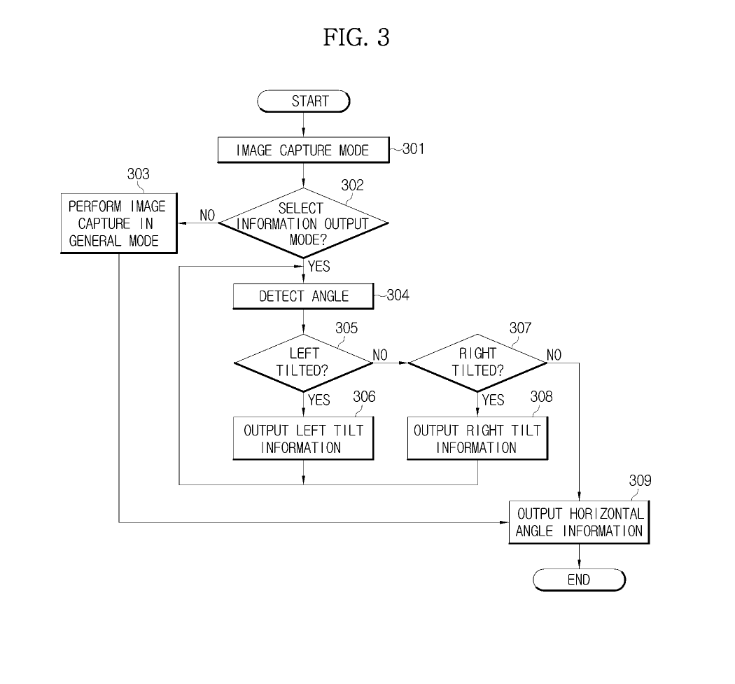

FIG. 3 is a flowchart illustrating a method of controlling an electronic apparatus, according to an embodiment.

When a command to initiate image capture is input to the first input unit, an image capture mode is initiated in the terminal device (301).

The terminal device determines whether the information output mode is selected (302). When the information output mode is not selected (NO of 302), an image is captured in a general mode (303). Here, the general mode is a mode in which only an image capturing operation is performed without outputting information regarding the photographing angle. In addition, the terminal device displays an image of an object on the display unit while capturing the image of the object.

On the other hand, when the terminal device determines that the information output mode is selected (YES of 302), the terminal device confirms input photographing conditions for the photographing angle. In this case, when input of the photographing conditions for the photographing angle is confirmed, the terminal device performs image capture based on the input photographing conditions. Here, the terminal device also displays the image of the object on the display unit while capturing the image of the object.

In the information output mode in which information regarding the photographing angle is output, the terminal device defines photographing conditions for taking an eye level shot in the landscape mode as reference values, i.e., default values.

That is, when the information output mode is selected by the user, but the photographing conditions are not input, the terminal device provides information regarding the current photographing angle to the user based on the default values.

When the information output mode is selected by the user, but the photographing conditions are not input, the terminal device determines that the user is trying to take an eye level shot in the landscape mode. Thus, the terminal device selects the landscape mode as the frame mode of the photographing conditions and sets the target angle to 0°.

The terminal device detects the angle of the image capturing module 120 mounted on the main body (304), and detects the tilt with respect to the horizontal line based on the detected angle.

Here, detecting the tilt is performed by defining the axis parallel to the horizontal line as the X-axis in the landscape mode and detecting the direction of the image capturing module is tilted with respect to the X-axis as the tilted angle.

The terminal device determines whether the image capturing module is tilted to the left with respect to the horizontal line (305). When the image capturing module is tilted to the left, the terminal device outputs left tilt information (306).

On the other hand, when the terminal device confirms that the image capturing module is not tilted to the left with respect to the horizontal line, the terminal estimates whether the image capturing module is tilted to the right (307). When the image capturing module is tilted to the right, the terminal device outputs right tilt information (308).

In addition, the terminal device calculates a difference between the current photographing angle and the horizontal angle, and changes the output information in accordance with the calculated angle.

For example, when the information regarding the photographing angle is output in the sound mode, the volume of the sound varies according to the angle. That is, when the image capturing module is tilted to the left such that the left thereof is disposed higher than the right side with respect to the horizontal line, the volume of the sound is controlled to increase depending on the difference.

In this regard, the volume of the sound corresponding to the angle difference may be preset.

When the terminal device determines that the image capturing module is parallel to the horizontal line, i.e., when the terminal device determines that the image capturing module has the horizontal angle, information indicating that the current photographing angle is identical to the horizontal angle is output (309).

When the information output mode is selected, and the photographing conditions are additionally input, the terminal device changes the default values based on the additionally input photographing conditions.

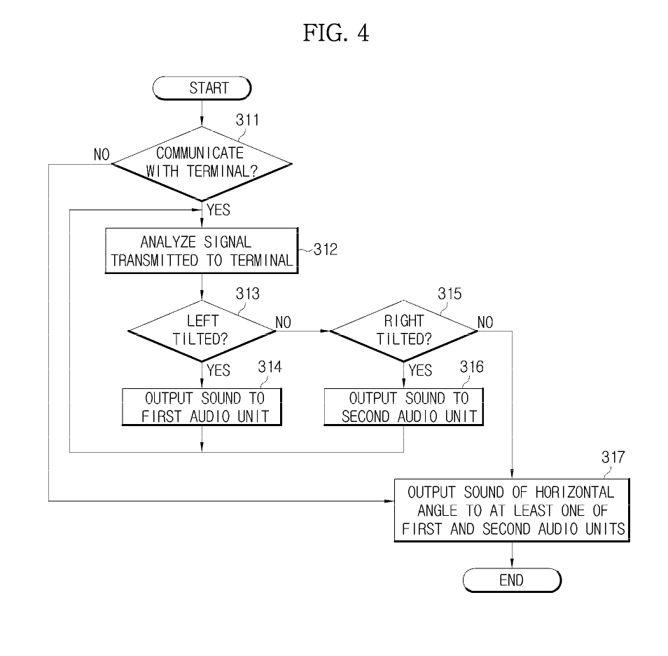

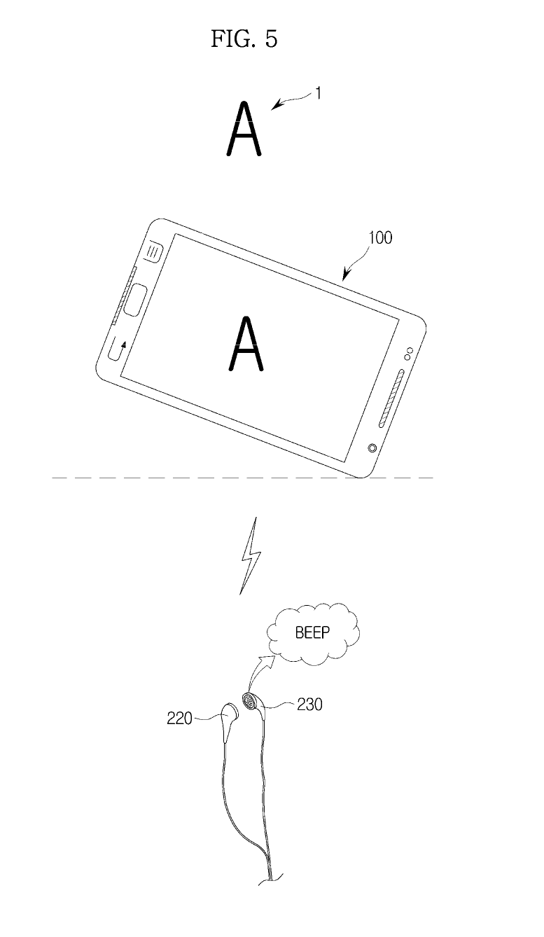

This will be described in more detail with reference to FIGS. 4 to 8. FIG. 4 is a flowchart illustrating a method for controlling a sound output device, as an external device, communicating with an electronic apparatus, according to an embodiment. FIGS. 5 to 8 exemplarily illustrate various output modes of an electronic apparatus, according to various embodiments.

First, an example of the embodiment will be described with reference to FIGS. 4 and 5.

Here, the additionally input photographing conditions include the landscape mode as the frame mode, the horizontal angle as the photographing angle, and the first external mode as the output mode.

When the terminal device determines that the image capturing module is tilted to the left side with respect to the horizontal line, the terminal device transmits a signal regarding left tilt information to the external device via the first communication unit.

On the other hand, when the terminal device determines that the image capturing module is tilted to the right side with respect to the horizontal line, the terminal device transmits a signal regarding right tilt information to the sound output device, as an external device, via the first communication unit.

Furthermore, when the signal regarding the tilt information is output through the first communication unit, the terminal device may output a sound signal having a volume corresponding to the difference between the current photographing angle and the horizontal angle.

When the terminal device determines that the image capturing module has the horizontal angle, a signal indicating that the current photographing angle is identical to the horizontal angle is transmitted to the sound output device, as an external device, via the first communication unit.

As illustrated in FIG. 4, the sound output device 200, as an external device, communicates with the terminal device to receive a signal from the terminal device (311), and the sound output device 200 analyzes the received signal (312).

The sound output device 200 determines whether the received signal is a signal regarding the left tilt (313). When the received signal is a signal regarding the left tilt, the sound output device 200 outputs a sound indicating the left tilt to the first audio unit applied to the left ear (314).

On the other hand, when the sound output device 200 confirms that the received signal is not the signal regarding the left tilt, the sound output device 200 determines whether the signal is a signal regarding the right tilt (315). When the signal is a signal regarding the right tilt, the sound output device 200 outputs a sound indicating the right tilt to the second audio unit applied to the right ear (316).

Here, the determining of whether the received signal is a signal regarding the left tilt includes determining whether the signal received by the second communication unit of the sound output device 200 is a signal including an output command to the first audio unit.

In addition, the determining of whether the received signal is a signal regarding the right tilt includes whether the signal received by the second communication unit of the sound output device 200 is a signal including an output command to the second audio unit.

As illustrated in FIG. 5, under the condition that an eye level shot of an object 1 in the landscape mode is taken using the terminal device 100, the terminal device 100 transmits a signal regarding right tilt information to the sound output device 200 via the first communication unit when the photographing angle of the main body is tilted to the right side with respect to the horizontal line. In this case, the sound output device 200 receives the signal regarding right tilt information and outputs a sound notifying the right tilt through the second audio unit 230.

When the received signal is a signal indicating the horizontal angle instead of the left or right tilts, the sound output device 200 outputs a sound notifying that the image capturing module is parallel to the horizontal line to at least one of the first audio unit and second audio unit (317 of FIG. 4).

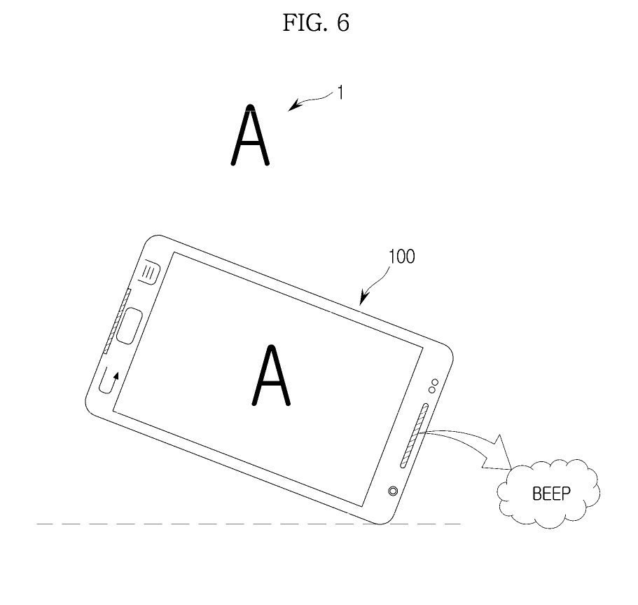

Another embodiment will be described with reference to FIG. 6.

Here, the additionally input photographing conditions include the landscape mode as the frame mode, the horizontal angle as the photographing angle, and the sound mode as the output mode.

The terminal device 100 turns on the image capturing module, detects the tilted angle with respect to the horizontal line, and detects the tilt of the image capturing module based on the detected angle.

When the terminal device 100 determines that the image capturing module is tilted to the left side with respect to the horizontal line, left tilt information is output using a first beep via the sound output unit.

As illustrated in FIG. 6, when the terminal device 100 determines that the image capturing module is tilted to the right side with respect to the horizontal line while capturing an image of the object 1, right tilt information is output using a second beep via the sound output unit.

When the terminal device 100 determines that the image capturing module has the horizontal angle, information indicating that the current photographing angle is identical to the horizontal angle is output using a third beep.

Here, the first beep, the second beep, and the third may be different. In addition, the terminal device 100 may also control the volume of the sound corresponding to the angle with respect to the horizontal line.

In addition, the first beep, the second beep, and the second beep may also be replaced with voice. For example, when terminal device 100 determines that the photographing angle corresponds to a left tilt, a voice announcing “the main body (or image capturing module) is tilted to the left” may be output. Furthermore, information regarding the tilted angle may also be output using a voice.

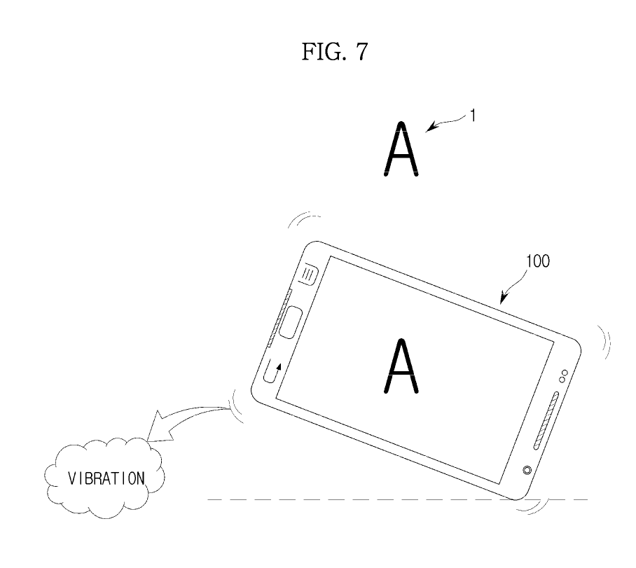

Another embodiment will be described with reference to FIG. 7.

The additionally input photographing conditions include the landscape mode as the frame mode, the horizontal angle as the photographing angle, and the vibration mode as the output mode.

The terminal device 100 turns on the image capturing module, detects the tilted angle with respect to the horizontal line, and detects the tilt of the image capturing module based on the detected angle.

When the terminal device 100 determines that the image capturing module is tilted to the left side or right side with respect to the horizontal line, the vibration unit is driven to generate vibration in order to indicate that the current photographing angle is a canted angle.

As illustrated in FIG. 7, when the terminal device 100 determines that the image capturing module is tilted to the left side or the right side with respect to the horizontal line while capturing an image of the object 1, vibrations indicating that the photographing angle is a canted angle are generated.

On the other hand, when the terminal device 100 determines that the image capturing module has the horizontal angle, the vibration unit is not driven such that vibrations are not generated to indicate that the photographing angle is identical to the horizontal angle.

Furthermore, the terminal device 100 may control the intensity of vibrations corresponding to the tilted angle with respect to the horizontal line. For example, the terminal device 100 may control the intensity of vibrations to increase as the canted angle increases.

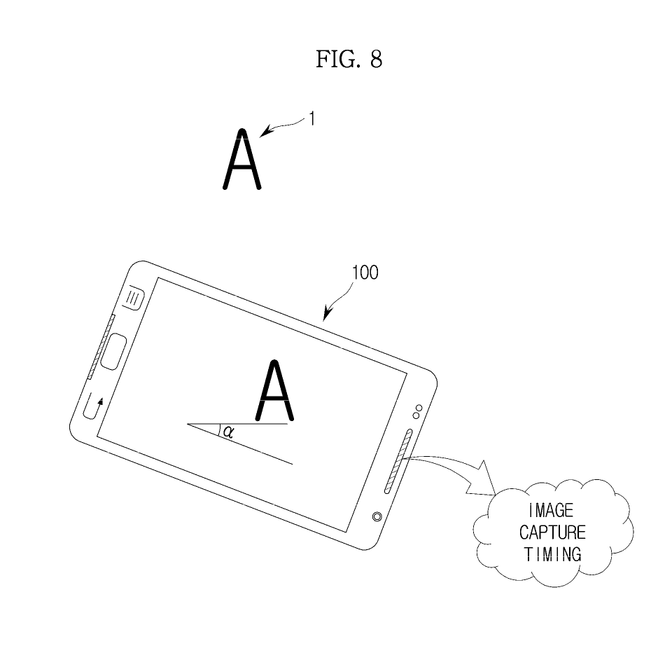

Another embodiment will be described with reference to FIG. 8.

The additionally input photographing conditions include the landscape mode as the frame mode, a target angle (α) as the photographing angle, and the sound mode as the output mode.

The terminal device 100 turns on the image capturing module and detects the tilted angle of the main body with respect to the horizontal line.

The terminal device 100 determines whether the image capturing module is tilted to the right side. When the terminal device 100 confirms that the image capturing module is tilted to the right side, the terminal determines whether the tilted angle is identical to the target angle (α).

As illustrated in FIG. 8, when the terminal device 100 determines that the image capturing module is tilted to the right side with respect to the horizontal line by target angle (α) while capturing an image of the object 1, a beep indicating that the photographing angle is identical to the target angle (α) is output.

In this case, a timing of outputting the beep is a suitable time for capturing an image of the object. That is, the beep is a sound indicating a suitable time for the image capture.

On the other hand, the terminal device 100 may output an announcement using a voice when the detected current photographing angle of the image capturing module is not the target angle. For example, the terminal device 100 calculates a difference between the current photographing angle and the target angle, and then outputs an announcement indicating the direction and the angle that the terminal device 100 should to be further tilted based on the calculated difference.

As described above, the electronic apparatus or the terminal device including an image capturing module may capture an image of the object at the horizontal angle or at a desired target angle by informing the user of the tilt of the main body or the image capturing module while displaying the image of the object on the display unit when capturing the image of the object.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

Although a few embodiments of the invention have been shown and described, it would be appreciated by those skilled in the art that changes may be made in these embodiments without departing from the principles and spirit of the invention, the scope of which is defined in the claims and their equivalents.

What is claimed is:

1. An electronic apparatus comprising:
a main body;
an image capturing module mounted on the main body and acquires an image of an object;
a detection unit mounted on the main body and detects an angle of the main body with respect to a horizontal line, wherein the horizontal line is perpendicular to an optical axis of a lens of the image capturing module and is parallel to the horizon;
a controller that determines a photographing angle of the object based on the detected angle of the main body; and
an output unit that outputs information regarding the photographing angle to an external device.

2. The electronic apparatus according to claim 1, wherein the photographing angle comprises:
a horizontal angle at which the main body is parallel to the horizontal line; and
a canted angle at which the main body is tilted to the left or right with respect to the horizontal line.

3. The electronic apparatus according to claim 2, wherein:
the output unit comprises an interface unit that communicates with the external device via a wired connection; and
the controller controls output of information regarding the horizontal angle and the canted angle to the external device via the interface unit.

4. The electronic apparatus according to claim 2, wherein:
the output unit comprises a communication unit that communicates with the external device via a wireless connection; and
the controller controls output of information regarding the horizontal angle and the canted angle to the external device via the communication unit.

5. The electronic apparatus according to claim 2, further comprising a storage unit that stores output information respectively corresponding to the horizontal angle and the canted angle,
wherein the controller controls output of output information corresponding to the horizontal angle when the photographing angle is the horizontal angle, and controls output of output information corresponding to the canted angle when the photographing angle is the canted angle.

6. The electronic apparatus according to claim 5, wherein the output information corresponding to the horizontal angle is different from the output information corresponding to the canted angle.

7. The electronic apparatus according to claim 5, wherein:
the controller determines whether the canted angle is a left tilt, wherein the main body is tilted to the left with respect to the horizontal line, or a right tilt, wherein the main body is tilted to the right with respect to the horizontal line; and
the controller controls output of output information corresponding to the right tilt when the canted angle is the right tilt, and controls output of output information corresponding to the left tilt when the canted angle is the left tilt.

8. The electronic apparatus according to claim 7, wherein the output information corresponding to the left tilt is different from the output information corresponding to the right tilt.

9. The electronic apparatus according to claim 7, wherein the output unit comprises a sound output unit that outputs output information corresponding to the horizontal angle, the right tilt, and the left tilt, using different sounds.

10. The electronic apparatus according to claim 7, wherein the output unit comprises a vibration unit that indicates output information corresponding to the horizontal angle and the canted angle using vibrations.

11. The electronic apparatus according to claim 1, further comprising a display unit mounted on the main body and displays an image of the object acquired using the image capturing module.

12. The electronic apparatus according to claim 11, wherein the display unit displays information regarding the horizontal angle and the canted angle.

13. The electronic apparatus according to claim 1, further comprising an input unit through which an information output mode to output information regarding the photographing angle is input,
wherein the information output mode comprises at least one mode selected from the group consisting of a sound mode, an announcement mode, a display mode, a vibration mode, a first external mode, and a second external mode.

14. The electronic apparatus according to claim 1, further comprising an input unit through which a target angle of the main body tilted with respect to the horizontal line is input,
wherein the controller determines whether the photographing angle is the target angle and controls the output unit to output information regarding an image capture time when the photographing angle is identical to the target angle.

15. A method of controlling an electronic apparatus comprising an image capturing module, the method comprising:
detecting an angle of the image capturing module with respect to a horizontal line when a command to initiate image capture is received, wherein the horizontal line is perpendicular to an optical axis of a lens of the image capturing module and is parallel to the horizon;
determining a photographing angle of an object based on the detected angle;
determining whether the determined photographing angle is a horizontal angle or a canted angle; and
outputting information regarding the determined photographing angle to an external device.

16. The method according to claim 15, wherein:
the determining of the photographing angle comprises determining whether the canted angle is a left tilt, where the image capturing module is tilted to the left with respect to the horizontal line, or a right tilt, where the image capturing module is tilted to the right with respect to the horizontal line; and
the outputting of information comprises outputting information regarding the right tilt when the canted angle is the right tilt and outputting information regarding the left tilt when the canted angle is left tilt.

17. The method according to claim 15, wherein the detecting of the angle of the image capturing module comprises:
confirming a frame mode; and
detecting the angle of the image capturing module with respect to the horizontal line.

18. The method according to claim 15, wherein the outputting of information comprises outputting information using at least one mode selected from the group consisting of a sound mode, an announcement mode, and a vibration mode.

19. The method according to claim 15, wherein the outputting of information comprises:
transmitting a left tilt signal to the external device when the photographing angle is a left tilt;
transmitting a right tilt signal to the external device when the photographing angle is a right tilt; and
transmitting a horizontal angle signal to the external device when the photographing angle is the horizontal angle.

20. The method according to claim 19, wherein:
the left tilt signal is a signal output through a first audio unit of the external device;
the right tilt signal is a signal output through a second audio unit of the external device; and
the horizontal angle signal is a signal output through at least one of the first audio unit and second audio unit of the external device.

21. The method according to claim 19, wherein the left tilt signal, the right tilt signal, and the horizontal angle signal are different sound signals.

22. The method according to claim 19, wherein the transmitting the signals to the external device comprises transmitting the signals to a sound output device, which communicates with the electronic apparatus via a wired or wireless connection.
